(19) United States
(12) Patent Application Publication
(10) Pub. No.: US 2004/0190851 A1
(43) Pub. Date: Sep. 30, 2004

(54) Two-dimensional optical element arrays

(76) Inventors: Sean M. Garner, Elmira, NY (US); James S. Sutherland, Corning, NY (US)

Correspondence Address: CORNING INCORPORATED, SP-TI-3-1, CORNING, NY, 14831

(21) Appl. No.: 10/403,139

(22) Filed: Mar. 31, 2003

(51) Int. Cl. G02B 6/00

(52) U.S. Cl. 385/137; 385/33; 385/134; 385/136

(57) ABSTRACT

Articles and methods for forming two-dimensional arrays of optical elements are disclosed. The articles and methods include providing an alignment substrate having apertures having the inner periphery of the apertures filled with a flexible gripper to provide an opening sized to grip an optical fiber. The articles and methods are useful for making arrays of optical elements including optical fibers and manufacturing optical devices.

### FIELD OF THE INVENTION

This invention relates to two-dimensional arrays of optical elements, methods of providing such arrays, and devices including such arrays.

### BACKGROUND OF THE INVENTION

Many photonic applications require precision alignment of one- and two-dimensional arrays of optical fibers to optical elements that emit or receive light. Examples of such optical elements include, but are not limited to, lenses, detectors, laser sources and other optical fibers. Particular examples of applications that require precision alignment of arrays of optical fibers to optical elements include two-dimensional fiber array connectors in optical data or communication applications, two-dimensional fiber-lens arrays for three-dimensional optical cross connection switches, and two dimensional fiber-detector arrays for broadcast and network interconnection schemes.

A challenge in assembly of two-dimensional optical element arrays is precision positioning of each fiber during alignment and attachment processes. Typical applications require each fiber to be placed on a two-dimensional array with a positional accuracy of less than 10 microns. Typical single-mode fiber alignment applications (to other fibers or optical elements such as lenses or laser sources) require lateral positional accuracy of less than 1-2 microns, while other applications require sub-micron positional accuracy. Many devices and methods have been provided for positioning fibers in two-dimensional arrays, including etched silicon alignment structures, alignment blocks with holes to guide fibers, and stacked structures that form fiber guides. In each of these devices and methods, the alignment structures provide relatively “hard” and inflexible surfaces for fiber alignment, leading to small misalignments in cases where the physical size of the optical element varies slightly from element to element across the array. In view of these limitations, improved methods and articles for aligning arrays of optical elements are needed.

### SUMMARY

The invention relates to methods and articles for forming two dimensional arrays of optical elements and devices formed using such methods and articles. According to certain embodiments, an alignment substrate is provided with an array of apertures, with the periphery of the apertures containing flexible material. The aperture lined with flexible material provides an opening sized to grip an optical element such as an optical fiber. The various embodiments of the present invention provide relatively simple and inexpensive methods and articles for forming arrays of optical elements and optical fibers. The methods and articles do not require adhesives for securing the elements to substrates. It is to be understood that both the foregoing general description and the following detailed description are exemplary and are intended to provide further explanation of the invention as claimed.

### BRIEF DESCRIPTION OF THE DRAWINGS

FIG. 1 is a partial perspective view of a substrate including a plurality of apertures used to make a two-dimensional optical element array according to one embodiment of the invention;

FIG. 2 is a perspective view of the substrate in FIG. 1 with curable material deposited on the substrate and filling the apertures according to one embodiment of the invention;

FIG. 3 is a perspective view of the substrate in FIG. 2 showing the step of curing of the curable material through a mask according to one embodiment of the invention; and

FIG. 4 is a perspective view of the alignment substrate shown in FIG. 3 after the curable material has been cured according to one embodiment of the invention;

FIG. 5 is a side view of the alignment substrate shown in FIG. 4;

FIG. 6 is a partial perspective view of an alignment substrate for forming two-dimensional optical element arrays according to another embodiment of the invention;

FIG. 7 is a side view showing a method of forming a two-dimensional optical element array alignment substrate according to an alternative embodiment;

FIG. 8 is a side view showing a method of forming a two-dimensional optical element array alignment substrate according to an another embodiment;

FIG. 9 is a side view showing optical fibers inserted into an alignment substrate and fiber guides according to one embodiment of the invention;

FIG. 10 is a side view showing optical fibers inserted into a two-piece alignment substrate and fiber guides according to one embodiment of the invention;

FIG. 11 is a side view showing a molded fiber guide structure integrated with an alignment substrate according to one embodiment;

FIG. 12 is a side view of the device shown in FIG. 11 with uncured curable material in the openings of the alignment substrate;

FIG. 13 is a side view of the device shown in FIG. 12 after the curable material has been cured through a mask;

FIG. 14 is a perspective view of an assembled two-dimensional optical fiber array interconnection using a pair of alignment substrates according to one embodiment of the invention;

FIG. 15(a)-(d) is a cross-sectional view of various opening shapes that can be used to form optical fiber gripping structures in a substrate containing apertures;

FIGS. 15(e)-(h) show the openings in FIGS. 15(a)-(d) with an optical fiber inserted in the openings;

FIG. 16 is a side view of a two-dimensional optical fiber array aligned to a array using an alignment substrate according to one embodiment;

FIG. 17 is a side view of a two-dimensional optical fiber array aligned to a microlens array using an alignment substrate and an additional layer of flexible gripping material according to one embodiment;

FIG. 18 is a side view of an optical fiber array passively aligned to a photodetector or VCSEL substrate using an alignment substrate according to one embodiment;

FIG. 19 is a side view of an optical fiber array in ferules passively aligned to ball lenses using an alignment substrate according to another embodiment;

FIG. 20 is a side view of optical fibers aligned to ball lenses using an alignment substrate and embossed chambers formed in the curable material according to another embodiment; and

FIG. 21 is a side view of optical fibers in ferrules aligned to ball lenses secured in curable material below a silica substrate according to one embodiment.

### DETAILED DESCRIPTION

Before describing several exemplary embodiments of the invention, it is to be understood that the invention is not limited to the details of construction or process steps set forth in the following description. The invention is capable of other embodiments and of being practiced or carried out in various ways.

The various embodiments of the present invention relate to articles and methods for forming two-dimensional arrays of optical elements. As used herein, an array refers to a general two-dimensional pattern that is not necessarily ordered rows and columns. According to one embodiment of the invention, a substrate or plate 10 used for forming two-dimensional array of optical element is shown in FIG. 1. FIG. 1 shows a substrate or plate 10 containing a plurality of apertures 12. As used herein, an aperture refers to, in general, any shaped opening extending partially or fully through the alignment substrate 10. The apertures 12 are not necessarily uniform in cross-section. The substrate 10 can be fabricated from a variety of suitable materials into which apertures are formed. Suitable materials for the substrate include, but are not limited to, rigid low-expansion glass, ceramic, metallic material, semiconductor substrates, as well as both filled and unfilled polymeric systems. The substrate provides a two-dimensional array of apertures on a fixed or variable pitch. The apertures 12 in the substrate 10 can be fabricated via a number of methods, including but not limited to stamping, photolithography, photolithographically-defined wet or dry chemical etching, or molding. The diameter of the apertures 12 in the substrate is selected to be slightly larger than the diameter of an optical fiber, an optical fiber ferrule, or other various optical elements.

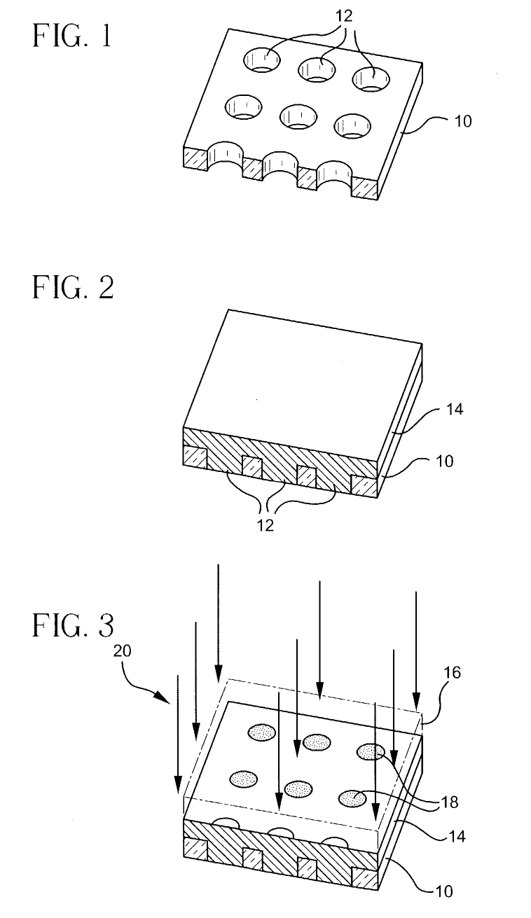

Referring now to FIG. 2, curable material 14 such as a curable polymer or monomer 14 can be deposited over the substrate 10 such that the apertures 12 are filled with the material. The curable material fills each aperture 12 in the aperture substrate 10 as the material 14 is drawn into the apertures 12 via surface tension. The curable material can be cured by heat or ultraviolet (UV) radiation. In preferred embodiments, the curable material is cured via UV radiation. Referring to FIG. 3, in preferred embodiments, a photolithographic mask 16 having masked areas 18 is placed over the UV-curable material 14. The masked areas 18 are positioned over the apertures 12 in the substrate shown in FIG. 1. The thickness of the curable material 14 can be controlled using precision standoff blocks or rods (not shown) placed between the mask 16 and the substrate 10 or integrated into the substrate or mask. Alternatively, the mask can be lowered onto precision standoffs placed on the substrate, or integrated into the substrate, prior to deposition of the curable material on the substrate; the curable material is thereafter drawn into the cavity formed between the mask and the aperture plate by surface tension.

Preferably, the masked areas 18 are circular and aligned to the apertures formed in the substrate. While perfect centering is not required, this alignment should ensure that some minimum margin distance exists between the edge of the circular mask pattern and the sides of the apertures in the substrate. This margin distance allows a portion of the curable material to be cured along the periphery of each aperture. In other embodiments, the diameter of the circular masked areas 18 is smaller than the diameter of the apertures 12 formed in the substrate 10, facilitating curing of material along and around the periphery of each aperture 12.

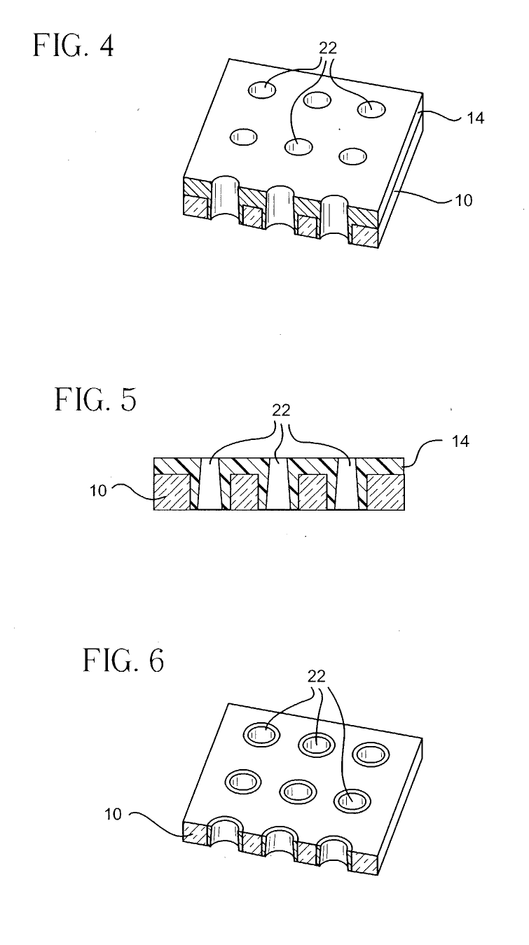

After the curable material is cured with UV light 20, the substrate 10 is immersed in a solvent to remove the that portion of the curable material which remains uncured, which is preferably a polymer gripper material in regions of the apertures where UV exposure was blocked by the mask. FIG. 4 shows the substrate 10 after the uncured material has been removed, leaving openings 22 through the curable material that are aligned to the apertures 12 in the substrate 10. The openings 22 are sized to grip an optical element such as an optical fiber, an optical fiber ferrule, or other various optical elements. A side view of the substrate is shown in FIG. 5. By varying the exposure and processing, a taper angle can be provided to the openings 22, and the angle of taper can be adjusted to suit the optical fiber gripping and guiding requirements. As shown in FIG. 5, the openings 22 taper from the bottom of the plate to the top of the plate 10. Also, the thickness of the substrate and wall angle is chosen to insure inserted fibers are parallel to each other.

Another embodiment is shown in FIG. 6. In this embodiment, the substrate 10 is provided, and curable material only fills the apertures. No excess material is on the upper portion of the substrate. Such a device can be provided by flowing curable material into the apertures. Excess curable material can be removed using a mask plate, squeegee, doctor blade, or release coating. Curing and patterning of the curable material via thermal or UV exposure through a mask and development are similar to the process discussed above so that the apertures have cured flexible material around their periphery, providing openings 22 for fibers to be inserted therethrough. As with the earlier described embodiment, the taper angle of the openings 22 can be varied by adjusting exposure and development conditions.

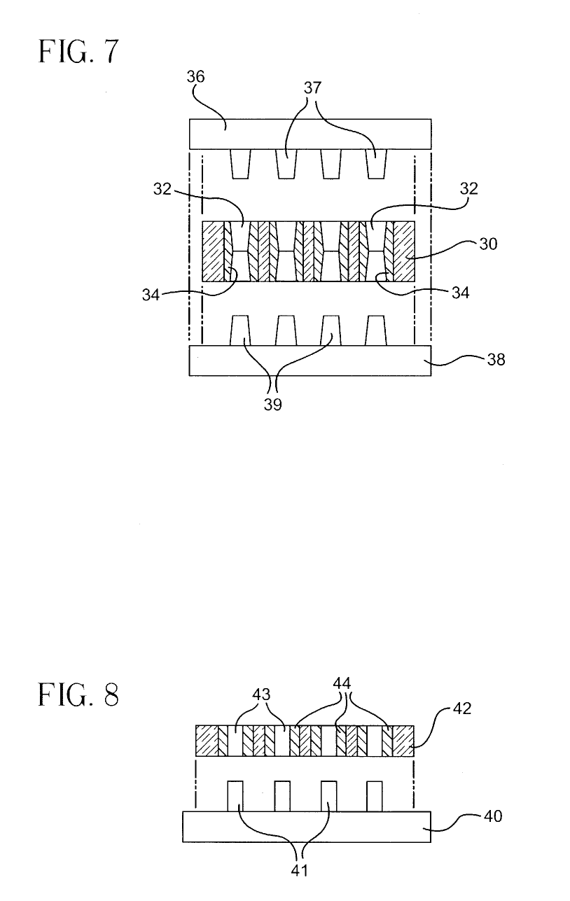

According to another embodiment shown in FIG. 7, tapered two-dimensional fiber guide holes could also be fabricated in a polymer substrate 30 using a double-sided molding process. The substrate 30 having openings 32 formed therein is used to provide mechanical stability to the array, while tapered curable material 34 in the openings provides passive fiber guiding and centering. Such a substrate is manufactured by first providing an upper mold 36 having pins 37 and a lower mold 38 having pins 39. The pins 37, 39 are positioned in the openings 32 of the substrate 30. Precise lateral positioning of the upper mold 36 to the lower mold 38 minimizes fiber coupling losses when fibers are inserted in opposite ends of the substrate openings. Also, the pins 37, 39 should contact each other within the opening in such a way as to guarantee that the opening 32 is not blocked with residual curable material 34 after the pins are removed. Curable material 34 is cured around the mold pins 37, 39. The shape of the pins 37, 39 allows a wide variety of wall angles and contact area to be created. In an alternative embodiment shown in FIG. 8, a single-sided embossing plate 40 having pins 41 can be positioned in openings 43 of substrate 42. Curable material 44 is deposited and cured around the pins 41. In a preferred embodiment, the openings have a cylindrical taper, which provides excellent fiber-to-fiber alignment even with small variations in pin diameter and position in the pin array. Also, by varying the shape or texture of the pin, a wide variety of sidewall surface textures, positive wall angles, and negative wall angles can be created if the curable material 44 is sufficiently flexible to allow release of the mold pins 41.

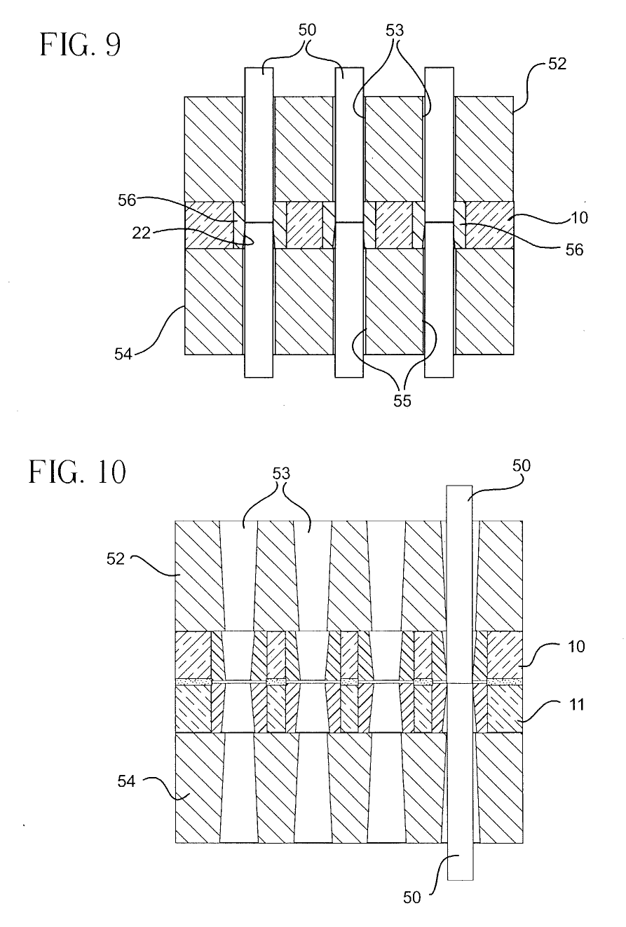

The two-dimensional alignment substrates including flexible material in and along the periphery of the openings of the substrate can be used to interconnect a wide variety of optical elements to optical fibers. Referring now to FIG. 9, a substrate 10 having tapered openings 22 including flexible material 56 on the inner periphery of the openings 22 adapted to grip optical fibers 50 is sandwiched between and in contact with two fiber guides 52, 54 having channels 53, 55 to guide the fibers 50 into the openings 22 in the substrate 10. The channels 53, 55 in the fiber guides can be molded, stamped, drilled or photolithographically etched. In use, an array of fibers 50 inserted into fiber guide plate 52 on one side of the aperture plate can be passively aligned to fibers inserted from the other side into fiber guide plate 54. The taper angle of the openings in the flexible material can be adjusted such that fibers are centered on the openings 22 when inserted into the channels 53, 55.

According to another embodiment shown in FIG. 10, a pair of fiber alignment substrates 10, 11 can be joined together. Preferably, the fiber alignment substrates 10, 11 are aligned prior to joining using two or more precision alignment pins (e.g., optical fibers). These alignment pins can be removed after the aperture plates are joined, or left in place if proper clearance is provided for them later. The fiber alignment substrates 10, 11 can then be sandwiched between two fiber guides 52, 54. Fibers 50 inserted into the molded fiber guides from either side of the two-piece alignment plate are aligned in the openings in the alignment substrates, which are preferably tapered openings. The fiber guides 52, 54 can also be molded with a tapered channel to simplify fiber array insertion.

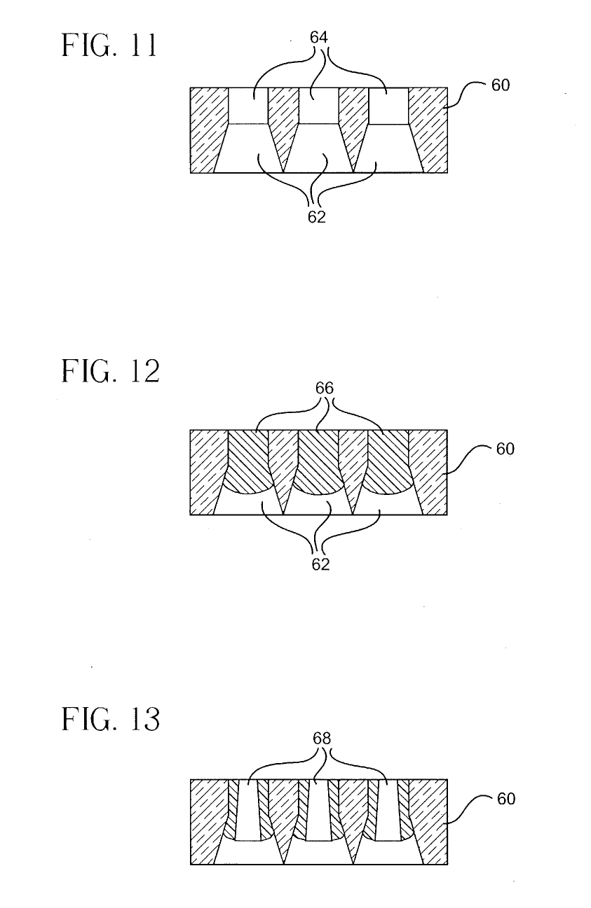

According to another embodiment, a fiber guide structure can be integrated with the fiber alignment substrate, as shown in FIG. 11. The alignment structure 60 includes tapered openings 62 formed on one end of the structure and straight apertures 64 formed on the opposite end of the structure 60. Just like the channels 53, 55, this structure can be formed by various molding, stamping, machining, and photolithography methods. Optical fiber grippers can be formed in the structure by flowing curable material 66 into the apertures 64 via capillary action or molding as shown in FIG. 12. After curing, preferably by ultraviolet exposure using a photolithography mask or mold tool, tapered openings 68 are formed in gripper material as shown in FIG. 13. To prevent the curable material 66 from completely filling or producing a narrow opening 68 completely through the flared regions, mold tools for example could be used. As noted above, the tapered openings 62 could be formed via molding, stamping, or any other process that gives the hole a tapered profile that provides a fiber coarse alignment to the polymer gripper hole. The absolute positioning of the hole is not critical. As mentioned above, the travel of curable material into the holes could be limited by capillary action or molding. In the case of capillary action, the alignment structure 60 could be coated in curable material on the surface closest to straight apertures 64. Curable material would be drawn into the straight apertures, but depending on the taper profile angle of the tapered opening 62 and the viscosity of the curable material, capillary action would only draw the curable material partially into the tapered opening 62. In the case of molding of the curable material, an additional tapered mold form (not shown in the drawings) could be forced into tapered opening 62 to shape curable material deposited within the straight aperture 60 and tapered opening 62. The desired taper shape of the curable material after molding would provide coarse guiding for an inserted fiber, directing it toward the precision UV-formed taper 68 formed later.

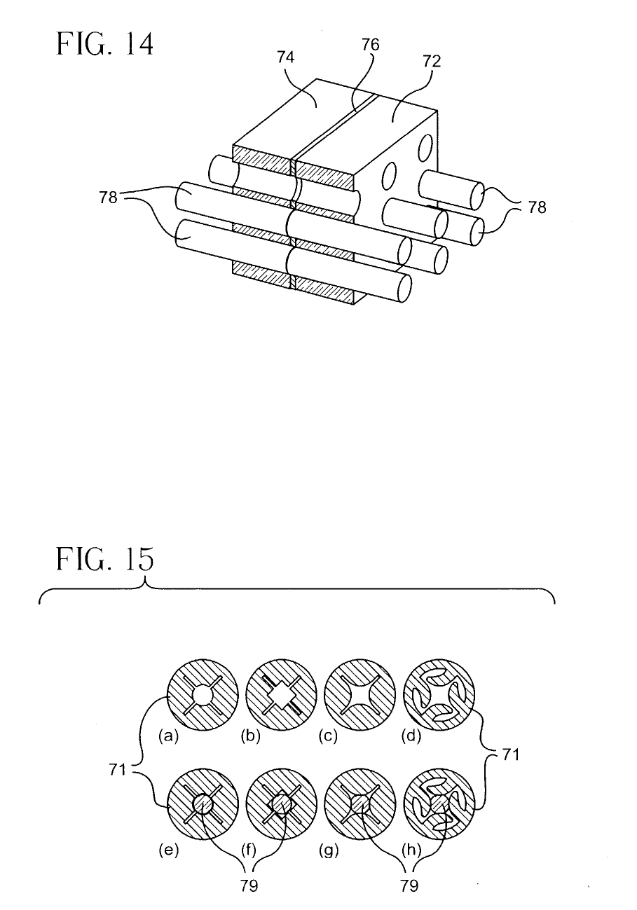

A variety of optical elements and devices can be interconnected to arrays of optical fibers using the two-dimensional optical fiber array alignment substrates of the present invention. A general view showing assembly of a two-dimensional optical fiber array interconnection is shown in FIG. 14. A pair of fiber guides 72, 74 sandwich an alignment substrate 76, including openings adapted to grip optical fibers 78. The optical fibers 78 are inserted into each fiber guide 72, 74 and through the alignment substrate 76 and abut to each other or an intermediate index matching layer. The flexible nature of the polymeric material on the periphery of the openings (not shown) in the alignment substrate 76 allows for precise alignment of the abutting fibers 78.

It will be understood that the openings for gripping fibers in the alignment substrate can be non-circular in shape. A variety of non-circular fiber gripper shapes are possible by varying the shape of the mask or mold prior to curing the curable material in the opening of the substrates. Several example shapes are provided in FIG. 15, where FIGS. 15a-d show the patterned fiber gripper opening shape, and FIGS. 15e-h show the gripper openings with a fiber 79 inserted therein. These various shapes would allow additional deformation of the gripper material during fiber insertion. This would permit use of stiffer polymer gripper materials that might provide additional advantages in securing and aligning the fibers. For example, the alignment substrate and gripping features might be fabricated completely out a single material, reducing the number of assembly steps and lowering overall alignment plate cost. The fabrication process for the openings with non-circular openings is identical to the process for circular openings, except, as noted above, that the shape of the mask or mold will correspond to the desired shape of the opening.

The alignment substrates, including openings with grippers formed therein, can also be used for alignment of a two-dimensional fiber array 80 to a two-dimensional microlens array 82, as shown in FIG. 16. An alignment substrate 84 is fabricated as described above with respect to FIGS. 1-5. A substrate with apertures formed therein can be provided and curable material can be cured through a mask to provide flexible material around the periphery of the apertures to form an opening adapted to grip an optical fiber. Optical fibers 86 are inserted through openings in the substrate. This process can occur before or after the alignment substrate 84 is attached to the lens array 82. In either case, it is preferred if the alignment substrate and fiber array are aligned to the lens array through the use of alignment marks, alignment pins, or active alignment techniques. In an alternative embodiment, a layer of curable material can applied to the back surface 83 of a microlens substrate, and either a photomask with opaque regions that define gripper opening locations or a mold is placed over the microlens substrate. The mask or mold is aligned to the microlenses 87, as slight lateral misalignments will lead to pointing errors across the array. Etched fiducials (not shown) in the microlens substrate could aid this mask-substrate alignment process. After mask or mold alignment, preferably ultraviolet light is used to cure polymer gripper material. Once the exposure is completed, the mask or mold is removed, and the unexposed gripper material is removed via development. This process leaves tapered openings 85 in the cured, flexible material aligned to the microlenses 87. In FIGS. 16-18, tapered openings 85 are shown with the larger diameter end lining up with the end of the fiber. While this configuration will provide accurate fiber alignment, the configuration where the smaller diameter end lines up with the fiber end will also provide some fiber guiding during fiber insertion. The angle of the taper can be adjusted by modifying exposure and development conditions. In this alternative embodiment, fibers 86 inserted into the tapered gripper holes will be passively aligned to lenses on the microlens substrate. After insertion, an adhesive 89 can be placed over the entire fiber array if required to fix it in place or serve as a strain relief.

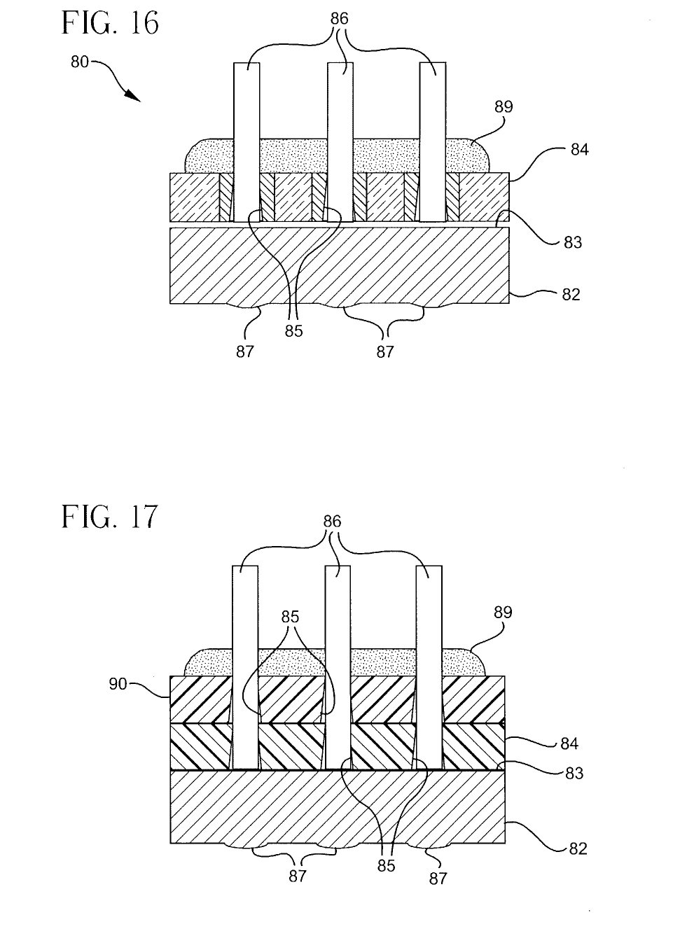

Multiple layers of fiber gripper material can be applied to the microlens substrate to provide additional stability to fiber arrays inserted in the grippers and also to provide corrugated features. FIG. 17 shows this approach used with a second layer 90 of curable material cured over the first layer 84. Similar shapes can be made using a molding process with proper release mechanisms. In FIG. 17, the taper of the openings in layer 90 and 84 the taper direction of the openings 85 is the same in each layer. It will be understood that the taper direction of the openings in adjacent layers can be reversed so that the two tapers are aligned so that their larger diameter ends are in contact.

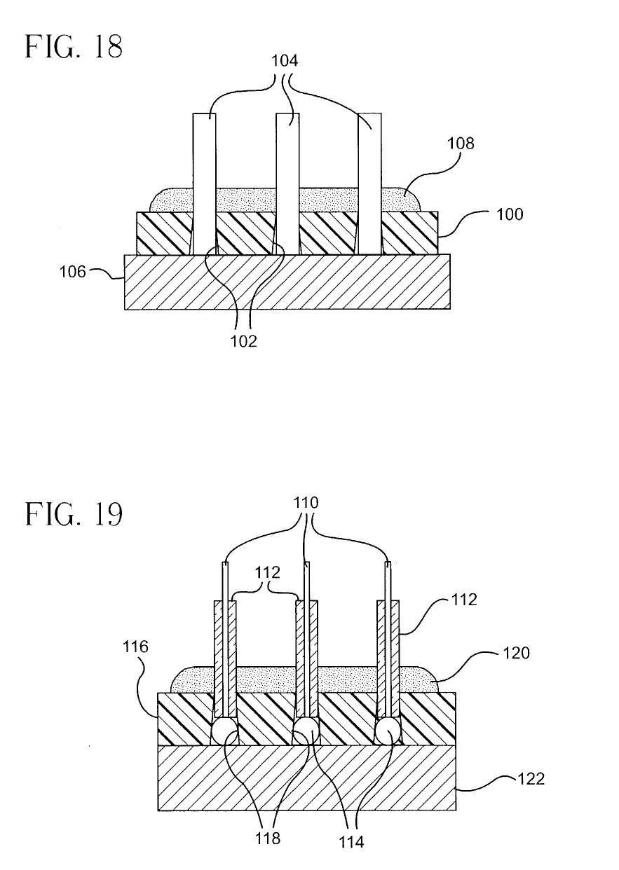

Alignment substrates of the present invention can also be used to align two dimensional arrays of optical fibers to detector arrays, VCSEL arrays or any other array of optical elements or optoelectronic components. A layer of curable material can be cured with openings therein adapted to grip optical fibers can be fabricated on an optically transparent substrate, with photodetector or VCSEL substrates aligned and attached separately. Alternately, alignment substrates similar to FIGS. 5, 6, or 13 with through-holes could be aligned directly to the optoelectronic substrate without the need for an optically transparent substrate. In one example of an integrated device shown in FIG. 18, a substrate 100 containing openings 102 formed therein adapted to grip optical fibers 104 is fabricated directly on top of the photodetector or VCSEL substrate 106, with an adhesive 108 over the substrate 100 to provide additional stability and strain relief.

The optical fiber alignment substrates can also be used to align other optical elements to optical fiber arrays. Referring to FIG. 19, optical fibers 110 contained in ferrules 112 are aligned to ball lenses 114 in a common substrate 116. Each ball lens 114 is aligned to each optical fiber 110 in a gripper opening 118 formed in the substrate 116, as shown in FIG. 19. The ferrules 112 are optional, and they are used to match the diameter of the ball lens 114 to the optical fibers 110. Fiber insertion into the ferrules can take place before or after the ferrules are inserted into the tapered gripper openings 118. Adhesive 120 could be used to hold the fibers and ferrules in place after assembly and provide strain relief. The entire assembly may be mounted to a substrate 122, which can be a silica plate or other appropriate substrate. Similar to the arrangement shown in FIG. 19, the ferrule can directly contain a lensed fiber. In this case, the ferrule containing the lensed fiber is inserted into the gripper opening 118 without the need for a ball lens. In this case, though, the lensed fiber working distance may be comparatively small, so the optional substrate 122 should be eliminated.

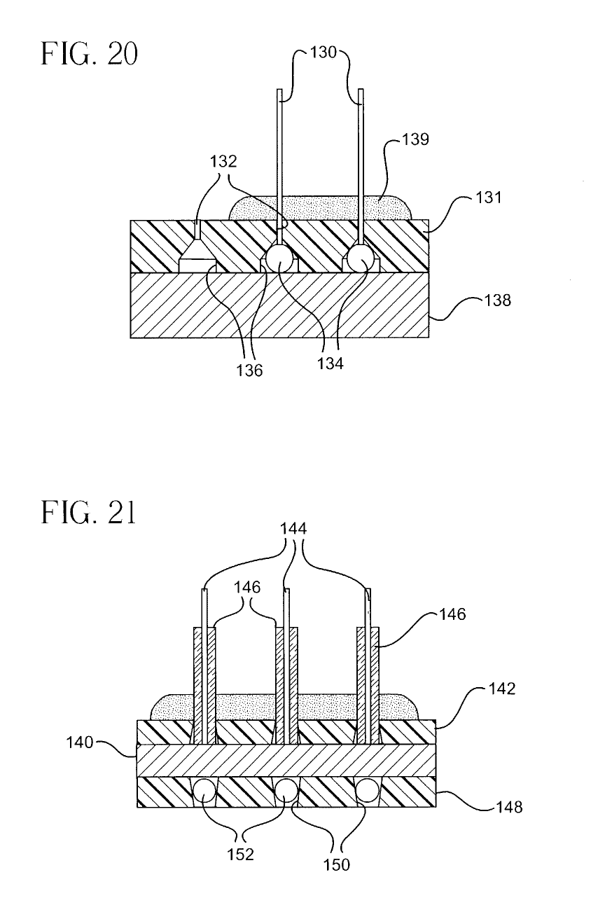

In an alternative embodiment shown in FIG. 20, the fiber ferrule can be eliminated by providing a gripper opening with two different gripping regions. In FIG. 20, fibers 130 are gripped in a first narrow gripper opening 132, and each lens 134 is gripped in a flared or wider gripper opening 136 formed in the alignment substrate 131 mounted on a silica substrate 138. The alignment plate containing fiber gripper openings 132 and ball lens gripper openings 136 structure could be fabricated by embossing or molding curable material with a tapered chamber that would align the lens to fiber. In this case, the alignment plate could be fabricated similar to the one described in FIG. 13. Adhesive 139 could be used to stabilize the structure and provide strain relief.

In another embodiment, fiber gripper openings are patterned on a first side of a substrate and lens gripper openings on an opposite side of the substrate, as shown in FIG. 21. FIG. 21 shows a substrate 140 having a first alignment substrate 142 for aligning optical fibers 144 contained in optional ferrules 146. A second alignment substrate 148 containing gripper openings 150 sized to hold ball lenses 152 is formed on the opposite side of the substrate 140.

It will be appreciated that a wide variety of two-dimensional arrays can be manufactured according to the various embodiments of the present invention. The number of gripping openings on a substrate can be increased to increase the number of channels for holding optical elements. It will also be understood that while the Figures show optical fibers, the invention can include articles adapted to secure optical fibers attached to other optical elements, for example, lenses, optical fiber ferrules, ball lenses, filter, such as thin film filters, detectors, gratings, etc. The articles of the present invention could be used to provide stacked arrays of optical fibers including lenses integrally formed on at least one end of the fibers. Because they use a similar geometry, the arrays of optical elements components can then be easily aligned to 2D arrays of optical fibers to create an optical system. The multiple 2D arrays of optical elements and fibers may or may not be joined by a common substrate as illustrated by substrate 116 in FIG. 19 or substrate 140 in FIG. 21.

The gripping elements formed on the inner periphery of the apertures of the substrates can be formed using well-known lithographic processes using photopolymerizable compositions and the like. For example, a photopolymerizable composition can be substantially uniformly deposited onto a substrate surface. The photopolymerizable composition is then imagewise exposed to actinic radiation using a laser and a computer-controlled stage to expose precise areas of the composition with an ultraviolet laser beam, or a collimated UV lamp together with a photomask having a pattern of substantially transparent and substantially opaque areas. The nonimaged areas can then be removed with solvent, while leaving the imaged areas in the form of at least one gripping element on the substrate surface.

The polymerizable composition may also be cured by various means such as actinic radiation or heat in combination with a molding tool. After removing the tool from the cured composition, at least one gripping element will remain on the substrate, depending on the nature of the pattern. The pattern of the tool may include a plurality of gripping elements to provide a substrate for aligning an array of fiber and lenses. Suitable polymeric compositions for making the gripping elements are disclosed in commonly assigned U.S. Pat. No. 6,266,472.

According to certain embodiments, the methods and articles of the present invention can be used to manufacture optical devices that incorporate an array of optical fibers. An exemplary optical device can be made by inserting a plurality of optical fibers in a plurality of openings formed in a substrate and securing individual fibers in the openings. In some embodiments, the optical fibers are positioned with respect to an optical element such as a prism including multiple thin film filters, a switching element such as a MEMS switch, an electroholographic switch or a LCD switch. According to various embodiments of the present invention, a variety of articles and methods for interconnecting two-dimensional arrays of optical fiber to other optical fibers, lenses, photodetectors, VCSELs or other optoelectronic devices, are provided. Flexible gripping structures with tapered or straight sidewalls are fabricated on a substrate using uncured polymeric or monomeric gripper material via relatively simple manufacturing processes, for example, photolithographic patterning and development, embossing, or molding. Optical elements are then aligned to the substrate and held in place by the flexible gripper material. The polymer gripper material deforms slightly to grip optical fibers or elements, and aligns each fiber or element to a pre-defined location in a two-dimensional grid. This self-alignment process also compensates for symmetric optical element geometrical variations such as changes in diameter of optical fibers or ball lenses.

The articles and methods of the present invention provide versatile structures that enable mass splicing, pigtailing, or connections to lens arrays. The articles can be incorporated in a two-dimensional fiber array splicing unit or in two dimensional fiber array connectors. The use of compliant gripper material in the openings of the substrate facilitates positioning and securing fibers and produces highly parallel fiber outputs required for channel uniformity. No complex micro-machining is required to fabricate the structures. The structures can be formed using standard photolithography or microreplication techniques.

Use of flexible gripping material in the openings material reduces tolerances for base-plate holes, enables use of variety of base-plate materials, enables multiple insertion/removals of fibers in the array, a variety of low tolerance base-plate fabrication steps can be used, and guarantees passive alignment of fibers with respect to each other. According to certain embodiments, flexible flaps can be fabricated out of polymeric or monomeric gripper material to help guide or hold fibers in the openings formed in the substrate. The fabrication of these flexible gripper structures is inherently low-cost because automated steps can be used that produce high yields that result in low cost of materials and labor.

It will be apparent to those skilled in the art that various modifications and variations can be made to the present invention without departing from the spirit or scope of the invention. For example, while many embodiments showed alignment substrates in which the apertures or openings extended through the substrates, in some embodiments, the aperture hole does not go completely through the alignment substrate. The description of FIG. 16 in which the alignment features are fabricated directly on top of the lens array is an example of this. In this case, a self-supporting aperture substrate with through-holes does not exist. Also, it may be useful to fabricate the alignment substrate with a non-uniform aperture before the gripping structure is formed. For example, an alignment substrate could be made with physical ledges at the bottom of the aperture. These ledges will serve as a “stop” when either a fiber or fiber ferrule is pushed in place. Thus, it is intended that the present invention cover modifications and variations of this invention provided they come within the scope of the appended claims and their equivalents.

What is claimed is:

1. An article for forming an optical element array comprising:
a substrate having a two-dimensional array of apertures therein arranged in a two-dimensional array, each aperture having material along and around the inner periphery of each aperture to provide an opening in the substrate adapted to grip an optical element placed therein.

2. The article of claim 1, wherein the material is curable by exposure to ultraviolet light.

3. The article of claim 2, wherein the curable material is a photopolymerizable polymer.

4. The article of claim 2, wherein the curable material is contained on at least one of the sides of the substrate.

5. The article of claim 4, wherein the openings in the substrate extend through the curable material contained on at least one of the sides of the substrate.

6. The article of claim 1, wherein the optical element includes an optical fiber and further comprises a fiber guide in contact with the substrate, the fiber guide having channels therein aligned with the openings of the alignment substrate.

7. The article of claim 6, wherein the substrate is in contact with and sandwiched between fiber guides having channels aligned with the openings of the substrate.

8. The article of claim 6, wherein the fiber guide is integrally formed with the alignment substrate.

9. An optical device including the article of claim 1.

10. The optical device including the article of claim 7, wherein the fiber guides are in an opposing relationship and having their channels aligned, wherein optical fibers are inserted in the channels of the opposing guides and the alignment substrate such that the fibers are aligned and placed in an abutting relationship.

11. An optical device according to claim 9, comprising fibers inserted through openings of the alignment substrate, the openings of the alignment substrate placed in alignment with an array of lenses.

12. The optical device of claim 11, wherein the lenses are formed on a substrate and the alignment substrate is placed in contact with the substrate.

13. The optical device of claim 12, wherein the lenses are formed on a side of the substrate opposite of the side in contact with the alignment substrate.

14. The optical device of claim 13, wherein a second alignment substrate having openings therein is placed in contact with the first alignment substrate.

15. The optical device of claim 11, wherein the array of lenses is an array of ball lenses.

16. The optical device of claim 15, wherein the ball lenses are secured in the openings of the alignment substrate.

17. The optical device of claim 16, wherein the alignment substrate includes flared openings sized to grip the ball lenses, wherein the flared openings are aligned with the openings sized to grip optical fibers.

18. The optical device of claim 17, wherein optical fibers are gripped within the openings and aligned with the ball lenses.

19. The optical device of claim 16, wherein a separate alignment substrate is provided including openings sized to grip the ball lenses and the substrate gripping the ball lenses is aligned with the fiber alignment substrate.

20. The optical device of claim 9, wherein the alignment substrate is placed in contact with an optical element.

21. A method of forming a two-dimensional optical element array device comprising:
forming a two-dimensional array of apertures through two sides of a substrate;
depositing a curable material into each aperture; and
curing the curable material to provide in inner periphery of each aperture a flexible gripper adapted to grip an optical element.

22. The method of claim 21, wherein the curable material is cured by ultraviolet radiation.

23. The method of claim 22, further comprising placing a mask over the curable material.

24. The method of claim 23, wherein the mask includes masked areas on the mask positioned over the apertures.

25. The method of claim 24, further comprising rinsing uncured material from the openings after the curing of the curable material.

26. The method of claim 25, further comprising forming a layer of curable material containing openings on at least one side of the substrate.

27. The method of claim 25, wherein the openings are circular in cross-section.

28. The method of claim 21, wherein the curing conditions are selected such that a tapered opening is formed in the alignment substrate.

29. The method of claim 25, further comprising inserting optical fibers in the openings.

30. A method of forming a two-dimensional optical element array device comprising:
providing a first mold having pins formed in a two-dimensional array;
surrounding the mold with curable material; and
curing the material around the mold to provide a substrate having a two-dimensional array of flexible openings sized to grip an optical element.

31. The method of claim 30, wherein the pins are tapered such that tapered openings are formed in the substrate.

32. The method of claim 31, further comprising providing a second mold having pins in a two-dimensional array and sandwiching the curable material between the molds prior to curing.

33. The method of claim 30, further comprising providing an alignment substrate with apertures therein, placing the pins in the apertures so that curable material flows between the pins and apertures, and curing the material between the pins and the apertures.

34. The method of claim 30 wherein the optical element is selected from the group comprising optical fibers, lenses, optical fiber ferrules, ball lenses, filters, detectors, and gratings.

35. The method of claim 30 wherein the pins are textured to provide a textured surface on the inside of the gripper apertures.
